(19) United States
(12) Patent Application Publication
(10) Pub. No.: US 2007/0020514 A1
(43) Pub. Date: Jan. 25, 2007

(54) Electrode for secondary battery

(75) Inventors: Kouki Ozaki, Inuyama (JP); Shigeru Inami, Inuyama (JP); Masanori Tsutsui, Inuyama (JP)

Correspondence Address: BROWDY AND NEIMARK, P.L.L.C.;624 NINTH STREET, NW, SUITE 300, WASHINGTON, DC, 20001-5303, US

(73) Assignee: Daido Metal Company Ltd., Nagoya (JP)

(21) Appl. No.: 11/489,523

(22) Filed: Jul. 20, 2006

(30) Foreign Application Priority Data
Jul. 20, 2005 (JP) 2005-209803

(51) Int. Cl. H01M 2/28

(52) U.S. Cl. 429/121

(57) ABSTRACT

The object of the present invention is to provide an electrode for secondary battery according to which the electrode density can be increased and furthermore the electric characteristics can be improved. In the present invention, the sheet material for electrode to be laminated on the surface of a current collector is prepared by mixing and kneading a powdered positive electrode active material or negative electrode active material and a finely powdered conductive material as main components to which a fluorine-containing polymer resin is added, screening the resulting mixture by a sieve to obtain particles of the mixture, adding a liquid lubricant to the particles, preforming the particles to make a sheet-like formed body, and stretching the sheet-like formed body in mono-axial or multi-axial direction.

### BACKGROUND OF THE INVENTION

The present invention relates to an electrode for secondary battery which comprises a sheet material for electrode comprising a powdered active material and a conductive material bound to each other and a current collector on the surface of which the sheet material is laminated.

Recently, nickel-hydride batteries, lithium ion batteries or electric double-layer capacitors are used as various backup power sources for automobiles and others. Among them, nickel-hydride batteries and lithium ion batteries which are secondary batteries have a feature that they have a higher energy density as compared with electric double-layer capacitors which do not involve any chemical reactions. As for the secondary batteries such as nickel-hydride batteries and lithium ion batteries, for example, in the case of the nickel-hydride battery disclosed in JP-A-10-112320, electrodes for the secondary battery are made by a method which comprises mixing a powdered active material such as nickel hydroxide of positive electrode or a hydrogen absorbing alloy of negative electrode, a conductive material powder, a binder component and a solvent to prepare a mix paste, coating or impregnating a metal foil (aluminum foil, copper foil or the like) or a metal mesh with the resulting paste, thereafter removing the solvent by drying, and rolling the metal foil or metal mesh.

In the method of coating or impregnating the current collector with the mix paste as disclosed in JP-A-10-112320, thickness of the mix coated on the surface of the current collector is at most about 100 μm, and it is difficult to coat the mix at a thickness more than about 100 μm. When the coat of the mix is thinner, the packing rate of active material in the electrode layer is low and the volume of active material is small, resulting in decrease of electrode density, and hence the current collector on which the mix has been laminated must be subjected to stretching treatment such as rolling or pressing for increasing the electrode density.

However, the stretching treatment causes damages such as occurrence of wrinkles and undulation in the metal foil which is a current collector, and when electrodes which are laminates comprising a mix and a current corrector are laminated together with separators in a case of a secondary battery, adhesion between them is damaged to cause deterioration of electric characteristics such as increase of electric resistance. Under the circumstances, the object of the present invention is to provide an electrode for secondary battery according to which electrode density can be increased and electric characteristics can be improved by controlling the electric resistance, and thus high-performance can be realized.

### SUMMARY OF THE INVENTION

For attaining the above object, the present invention provides an electrode for secondary battery comprising a current collector and a sheet material for electrode comprising a powdered active material and a conductive material bound to each other, said sheet material being laminated on the surface of the current collector, wherein the sheet material for electrode is a continuous fine porous structure body obtained by preforming into a sheet a mixture comprising the powdered active material and the conductive material which are three-dimensionally bound to each other with a fiberized fluorine-containing polymer resin and furthermore stretching the resulting sheet-like formed body in mono-axial or multi-axial direction.

Preferably, the above sheet material for electrode has a void content of 15-30% and a thickness of 70-350 μm.

Preferably, the above sheet material for electrode has a peel strength in the thickness direction of 0.01-0.07 N/mm² and a tensile strength in the stretching direction of 0.02-0.05 N/mm² which are measured by a mono-axial tensile strength tester.

Preferably, the fluorine-containing polymer resin is a polytetrafluoroethylene resin.

### DETAILED DESCRIPTION OF THE INVENTION

With respect to the sheet material for electrode laminated on the surface of a current collector in the present invention, a powdered positive electrode active material or negative electrode active material and a finely powdered conductive material as main components to which a fluorine-containing polymer resin is added are mixed and kneaded to prepare a mixture, this mixture is chopped fine and screened by a sieve to obtain particles of the mixture, a liquid lubricant is added to the particles, then the particles are preformed to make a sheet-like formed body, and furthermore the sheet-like formed body is stretched in mono-axial or multi-axial direction, and thus the sheet material for electrode can be made to a desired thickness at a stage before the sheet material is laminated on the current collector. The sheet material for electrode stretched as mentioned above has a continuous fine porous structure in which the powdered active material and conductive material are three-dimensionally bound to each other with a fiberized fluorine-containing polymer resin. Therefore, the sheet material has voids therein, and the void content can be adjusted by the stretching process.

Here, the thickness and void content of the sheet material for electrode will be explained. The electrode for secondary battery is composed of an electrode laminate comprising a current collector and electrode layers laminated on the surface (on the both surfaces) of the current collector. Therefore, when the electrode laminate is packed in a battery case of a given capacity, if the electrode laminate is thin, the electrode laminate becomes long, but the proportion of volume occupied by the current collector is large and the proportion of the electrode layer containing the active material is small, and, as a result, volume of the active material decreases and thus the electrode density cannot be increased. Therefore, although it is preferred to increase the thickness of the electrode layer because volume of the active material increases, if the electrode layer is too thick, degree of penetration of electrolyte is deteriorated and movement of ions may be hindered. However, as the electrode for secondary battery, there is generally employed a method of increasing the proportion of the volume of the active material, and to increase the thickness of the electrode layer as in the present invention is included in this method.

On the other hand, the void content of a sheet material for electrode affects the degree of penetration of electrolyte or mobility of ions, and there are problems that when the void content is low, the degree of penetration of electrolyte decreases and mobility of ions also deteriorates and when the void content is high, the electrode density decreases.

In the present invention, the mixture is preformed and further subjected to stretching process in mono-axial or multi-axial direction to form a sheet material for electrode, and hence the sheet material can be adjusted to a desired thickness to increase the volumetric proportion of the active material in the electrode layer and simultaneously the void content can be adjusted, and, as a result, the electrode density can be increased. For these reasons, the void content is preferably 15-30% and the thickness is preferably 70-350 μm. The adjustment of void content and thickness which relate to mechanical strength of the sheet material for electrode is preferably carried out in such a manner that the sheet material has mechanical strengths of a peel strength in thickness direction of 0.01-0.07 N/mm² and a tensile strength in stretching direction of 0.02-0.05 N/mm². If the peel strength in thickness direction and the tensile strength in stretching direction are less than the lower limit, packing rate of active material in the sheet material for electrode lowers to cause decrease of electric capacity and failure in continuous processing of sheet in mass production of the sheet materials for electrode. On the other hand, if the peel strength and tensile strength exceed the upper limit, the sheet material for electrode becomes too dense, causing deterioration in penetration of electrolyte and mobility of ions.

Furthermore, the sheet material for electrode is subjected to a processing for increase of electrode density before being laminated on the current collector as mentioned above, and the stretching process is not carried out after the sheet material for electrode is laminated (adhered with an adhesive) on the current collector. Therefore, the metal foil as a current collector does not suffer from damages such as occurrence of wrinkles and undulation, and when the electrodes which are in the form of laminate are laminated together with separators in a case of secondary battery, adhesion between the electrode and the separator can be ensured and improvement of electric characteristics such as electric resistance can be attained.

In the present invention, as for the powdered active material, in the case of a nickel-hydride battery, nickel hydroxide is mainly used as the powdered active material of positive electrode, and a hydrogen absorbing alloy (an intermetallic compound such as LaNi₅, TiMn₂, TiFe or Mg₂Ni, a Ti—V solid solution alloy, or the like) is mainly used as the powdered active material of negative electrode. In the case of a lithium ion battery, lithium cobalt oxide is mainly used as the powdered active material of positive electrode, and a carbon material (carbon, carbon fibers, or the like) is mainly used as the powdered active material of negative electrode.

Carbon black is mainly used as the conductive material.

An aluminum foil, nickel foil, copper foil, or the like is mainly used as the current collector.

As the fluorine-containing polymer resin, there is mainly used polytetrafluoroethylene (PTFE), ethylene-tetrafluoroethylene copolymer, chlorotrifluoroethylene copolymer, vinylidene fluoride polymer, tetrafluoroethylene-perfluoroalkylvinyl ether copolymer, or the like. PTFE is particularly preferred because it has heat resistance and chemical resistance.

### DESCRIPTION OF PREFERRED EMBODIMENTS

Examples of the present invention will be explained below. As an Example, explanation will be made of a sheet material for positive electrode of a lithium ion battery. The materials used for this sheet material for electrode are lithium cobalt oxide (LiCoO₂) as a powdered active material, carbon black (CB) as a conductive material, and a powder of polytetrafluoroethylene resin (PTFE) as a fluorine-containing polymer resin. The mixing proportion by mass of the materials is such that when the proportion of LiCoO₂ is assumed to be 100, CB and PTFE are 4, respectively.

First, at the first step, the respective materials are weighed so as to give the above proportion. Then, at the second step, the materials are introduced into a mixer to mix them by a rotating agitation blade, and, furthermore, at the third step, the mixture is transferred into a vessel of a kneader kept at a given temperature (e.g., 90° C.) and kneaded by a rotating blade under application of pressure. PTFE is fiberized by the mixing at the second step and the kneading at the third step to entangle LiCoO₂ and CB, resulting in a mixture in which they are three-dimensionally bound to each other and which is a structure body having a suitable void.

Then, at the fourth step, the mixture kneaded by the kneader is chopped fine by a chopper to obtain fine particles, which are then screened by a sieve. In this example, the particles are screened so that particles of 20 mesh or less (0.8 mm or less) can be used. Thereafter, at the fifth step, the particles to which a given amount of isopropyl alcohol (IPA) is added as a liquid lubricant are subjected to a pretreatment of mixing by a mixer to obtain a mixture. Then, at the sixth step, the resulting mixture is introduced in a hopper of a calendering machine and passed between two rollers to preform the mixture into a sheet-like material. The resulting sheet-like material formed by the preforming is wound up by a wind-up roller, and the thickness of the preformed sheet-like material is thicker 20-30% than that of the final product. Furthermore, at the seventh step, the sheet-like material is stretched by passing between two rollers so as to give the thickness of the final product. By carrying out this stretching process a plurality of times (e.g., 2-3 times), a void content of 15-30% can be attained, and besides a sheet-like electrode having a given thickness, for example, 70-350 μm is formed. By the stretching at the sixth step and the seventh step, the fiberization of PTFE is also accelerated and adjustment of the void content is carried out in addition to the adjustment of the thickness. The stretching process by rollers is basically a stretching in mono-axial direction, but a single sheet-like electrode may be stretched in multi-axial direction.

The sheet material for electrode formed through the first step to the seventh step mentioned above is subjected to lamination process which comprises laminating the sheet material on both surfaces (on one surface at a time) of a current collector with an adhesive, followed by drying (hot-air drying or, if necessary, vacuum drying) for removal of water or IPA contained in the sheet material for electrode to obtain an electrode for secondary battery.

As the sheet materials for electrode made through the above steps, a plurality of test pieces of positive electrodes for lithium ion battery were prepared using LiCoO₂, CB and PTFE at a proportion of 100:4:4 as mentioned above. The test piece of Example 1 had a peel strength of 0.01 N/mm² and a tensile strength in stretching direction of 0.02 N/mm² when the thickness of the electrode was 350 μm and the void content was 30%, the test piece of Example 2 had a peel strength of 0.06 N/mm² and a tensile strength in stretching direction of 0.04 N/mm² when the thickness of the electrode was 200 μm and the void content was 20%, and the test piece of Example 3 had a peel strength of 0.07 N/mm² and a tensile strength in stretching direction of 0.05 N/mm² when the thickness of the electrode was 100 μm and the void content was 15%. In the above three Examples, all the sheet materials for electrode satisfied the strength required for mass production, and besides the proportion of the volume of the active material in the electrode layer could be increased by adjusting the sheet material to the desired thickness and the void content could also be adjusted, and thus increase of electrode density could be attained.

1. An electrode for secondary battery comprising a current collector and a sheet material for electrode comprising a powdered active material and a conductive material bound to each other, said sheet material being laminated on the surface of the current collector, wherein the sheet material for electrode is a continuous fine porous structure body obtained by preforming into a sheet a mixture comprising the powdered active material and the conductive material which are three-dimensionally bound to each other with a fiberized fluorine-containing polymer resin and furthermore stretching the resulting sheet-like formed body in mono-axial or multi-axial direction.

2. An electrode for secondary battery according to claim 1, wherein the sheet material for electrode has a void content of 15-30% and a thickness of 70-350 μm.

3. An electrode for secondary battery according to claim 1, wherein the sheet material for electrode has a peel strength in the thickness direction of 0.01-0.07 N/mm² and a tensile strength in the stretching direction of 0.02-0.05 N/mm².

4. An electrode for secondary battery according to claim 2, wherein the sheet material for electrode has a peel strength in the thickness direction of 0.01-0.07 N/mm² and a tensile strength in the stretching direction of 0.02-0.05 N/mm².

5. An electrode for secondary battery according to claim 1, wherein the fluorine-containing polymer resin is a polytetrafluoroethylene resin.

6. An electrode for secondary battery according to claim 2, wherein the fluorine-containing polymer resin is a polytetrafluoroethylene resin.

7. An electrode for secondary battery according to claim 3, wherein the fluorine-containing polymer resin is a polytetrafluoroethylene resin.

8. An electrode for secondary battery according to claim 4, wherein the fluorine-containing polymer resin is a polytetrafluoroethylene resin.
